(19) United States
(12) Patent Application Publication
(10) Pub. No.: US 2017/0092409 A1
(43) Pub. Date: Mar. 30, 2017

(54) Preferentially Magnetically Oriented Ferrites for Improved Power Transfer

(71) Applicant: Apple Inc., Cupertino, CA (US)

(72) Inventor: Christopher S. Graham, Cupertino, CA (US)

(21) Appl. No.: 15/272,379

(22) Filed: Sep. 21, 2016

Related U.S. Application Data
(60) Provisional application No. 62/235,420, filed on Sep. 30, 2015.

(51) Int. Cl. H01F 27/24; H02J 7/02; H01F 41/02; H02J 50/90; H01F 41/04; H01F 27/28; H02J 50/10

(52) U.S. Cl. CPC H01F 27/24; H01F 27/28; H02J 7/025; H02J 50/10; H02J 50/90; H01F 41/04; H01F 41/02

(57) ABSTRACT

The present disclosure includes systems and methods for magnetically orienting ferrites in an inductive power transfer system. In one example embodiment, a method for forming a ferrite element having oriented magnetic dipoles includes heating a ferrite element to a first temperature, the ferrite element comprising a non-magnetic matrix having magnetic particulates suspended therein, and, while heating, applying an external magnetic field to the ferrite element to align magnetic dipoles of the particulates with the direction of the magnetic field.

### FIELD

The disclosure relates generally to inductive power transfer systems in electronic devices, and more particularly to systems and methods for magnetically orienting ferrites to improve inductive power transfer in electronic devices.

### BACKGROUND

Many electronic devices include one or more rechargeable batteries that require external power to recharge from time to time. Often, these devices may be charged using a similar power cord or connector, such as, a universal serial bus (“USB”) connector. However, despite having common connection types, multiple devices often require separate power supplies with different power outputs. These separate power supplies can be burdensome to use, store, and transport from place to place. As a result, the benefits of device portability may be substantially limited.

To account for these and other shortcomings of portable electronic devices, some devices include an inductive power transfer system. The user may simply place the electronic device on an inductive charging surface of a charging device in order to transfer energy from the charging device to the electronic device. Inductive charging uses a magnetic field to transfer energy allowing compatible devices to receive power though this induced current rather than using conductive wires and cords. Induction chargers typically use an induction coil to create an alternating electromagnetic field and a second induction coil in the electronic device takes power from the electromagnetic field and converts it back into electrical charge to charge the battery.

Traditionally, induction coils are formed from one or more wire windings wrapped around a solid core or base material. By passing an alternating electric current through the wire windings, an electromagnetic field may be generated around the induction coil. The electromagnetic field produced by the coil may induce current flow in other components that are within the field and may be used to transfer power between two or more components.

In some cases, the base is formed of a ferromagnetic material such as ferrite. In such embodiments, energy or work is required to align magnetic dipoles of the ferrite base with the generated electromagnetic field around the induction coil.

### SUMMARY

The present disclosure includes systems and methods for magnetically orienting ferrites in an inductive power transfer system. In one example embodiment, a method for forming a ferrite element having oriented magnetic dipoles includes heating a ferrite element to a first temperature, the ferrite element comprising a non-magnetic matrix having magnetic particulates suspended therein, and, while heating, applying an external magnetic field to the ferrite element to align magnetic dipoles of the particulates with the direction of the magnetic field.

In some embodiments, heating the ferrite element to the first temperature partially sinters the ferrite element, and heating the partially-sintered ferrite element to a second temperature fully sinters the ferrite element. The external magnetic field may be applied to the ferrite element between heating the ferrite element to the first temperature and heating the partially-sintered ferrite element to the second temperature.

In some cases, the ferrite element is configured to hold an induction coil. The aligned magnetic dipoles of the particulates may be aligned with a magnetic field of the induction coil during operation of the induction coil. In some embodiments, the aligned magnetic dipoles aligned with the magnetic field may increase the permeability of the ferrite element. The increased permeability of the ferrite element may improve power transmission efficiency of the induction coil.

Some embodiments are directed to a method for improving power transmission in an inductive power transfer system. A coil substrate may be formed from a ferrite material, wherein the ferrite material may have substantially unidirectionally oriented magnetic dipoles. An induction coil may be disposed on a surface of the coil substrate.

In one example, the coil substrate may be formed by a process including: heating the ferrite material to a threshold temperature; and applying a magnetic field to the ferrite material during heating to align magnetic dipoles of the ferrite material with the magnetic field. In some embodiments, the magnetic dipoles of the ferrite material may be oriented in a direction corresponding to a direction of an intersecting magnetic field of the induction coil.

In one example, the coil substrate may be formed by forming two or more substrate components from a ferrite material, the two or more substrate components each comprised of oriented magnetic dipoles. The two or more substrate components may be joined to form the coil substrate, and an induction coil may be formed on a surface of the coil substrate.

In some cases, the two or more substrate components may be formed by: forming the two or more substrate parts each forming a distinct portion of a coil substrate having a combined shape capable of receiving the induction coil; heating each of the two or more substrate parts to a threshold temperature; and during heating of each of the two or more substrate parts, applying a magnetic field to each of the two or more substrate parts to generally align magnetic dipoles of the ferrite material with the magnetic field being applied. Joining the two or more substrate components may result in a coil substrate having an aggregate magnetic dipole orientation that substantially aligns with a magnetic field of the induction coil in an inductive power transfer system.

In some embodiments, an induction coil substrate may include a ferrite material having substantially unidirectionally oriented magnetic dipoles, and a coil-receiving region on a surface of the substrate. In some cases, an induction coil may be in the coil-receiving region. In one embodiment, the magnetic dipoles of the ferrite material may be substantially aligned with an intersecting magnetic field of the induction coil during operation of the induction coil. The alignment of the magnetic dipoles may improve power transmission efficiency of the induction coil.

In one example, the coil substrate may be formed of two or more parts, each comprised of a ferrite material having substantially unidirectionally oriented magnetic dipoles. In some cases, the magnetic dipoles of each part may respectively substantially align with an intersecting magnetic field of an induction coil in the coil-receiving region.

In some embodiments, the ferrite material having substantially unidirectionally oriented magnetic dipoles may be formed in a process that simultaneously sinters and applies an external magnetic field to the substrate. In one example, applying an external magnetic field may substantially aligns the magnetic dipoles of the ferrite material with the magnetic field.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A depicts one example of a ferrite substrate element suitable for receiving an induction coil of the inductive energy transfer system;

FIG. 1B depicts a cross-sectional view of the ferrite substrate element taken along line B-B in FIG. 1A;

FIG. 2A depicts a cross-sectional view of a first implementation of the ferrite substrate element of FIG. 1A, taken along B-B in FIG. 1A, and an induction coil;

FIG. 2B depicts a detailed view of a portion of the ferrite substrate element of FIG. 2A having randomly aligned magnetic dipoles;

FIG. 3 depicts one example of applying a magnetic field to the ferrite substrate element of FIG. 1A;

FIG. 4A depicts a cross-sectional view (cross-hatching removed for ease of viewing) of one example implementation of the ferrite substrate element of FIG. 1A, taken along B-B in FIG. 1A, having aligned magnetic dipoles,

FIG. 4B depicts a detailed view of a portion of the ferrite substrate element of FIG. 4A after applying a magnetic field, the ferrite coil substrate comprising aligned magnetic dipoles;

FIG. 5 depicts an example process for forming a ferrite element having oriented magnetic dipoles;

FIG. 6 depicts an example process for applying a magnetic field to a ferrite element to orient the magnetic dipoles

FIGS. 7A and 7B depict one example of applying magnetic fields to a ferrite substrate element in discrete parts;

FIG. 8A depicts a cross-sectional view (cross hatching removed for ease of viewing) of one example ferrite substrate formed of discrete parts, each part having magnetic dipoles aligned with the direction of a magnetic field that was applied to the part;

FIGS. 8B and 8C depict detailed views of portions of the ferrite substrate element of FIG. 8A;

FIGS. 9 and 10 depict one example of an inductive energy transfer system;

FIG. 11 depicts a simplified, cross-sectional view of a portion of the inductive energy transfer system taken along line 11-11 in FIG. 10.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments described herein are related to an inductive energy transfer system. More specifically, the examples provided herein are directed to systems and methods for forming a coil substrate of an induction coil assembly.

For purposes of the description of the following examples, an induction coil assembly may include, for example, a substrate, and one or more conductive windings of an induction coil combined to form an electrically inductive part, such as a transmitter coil and receiver coil. In some cases, the coil substrate may be formed of a ferrite material having desirable material properties for use in an induction coil assembly, such as being non-conductive and experiencing low losses at high frequencies.

In order to produce the most efficient and/or effective energy transfer between two or more components, the magnetic dipoles of the ferrite substrate may be oriented to align with one another by an electromagnetic field that is generated around the induction coil during inductive power transmission. The dipoles will align along the field lines. The devices and techniques described herein may be used to form a ferrite substrate having oriented magnetic dipoles in order to increase the magnetic permeability of the ferrite substrate and thus improve inductive energy transfer efficiency between components.

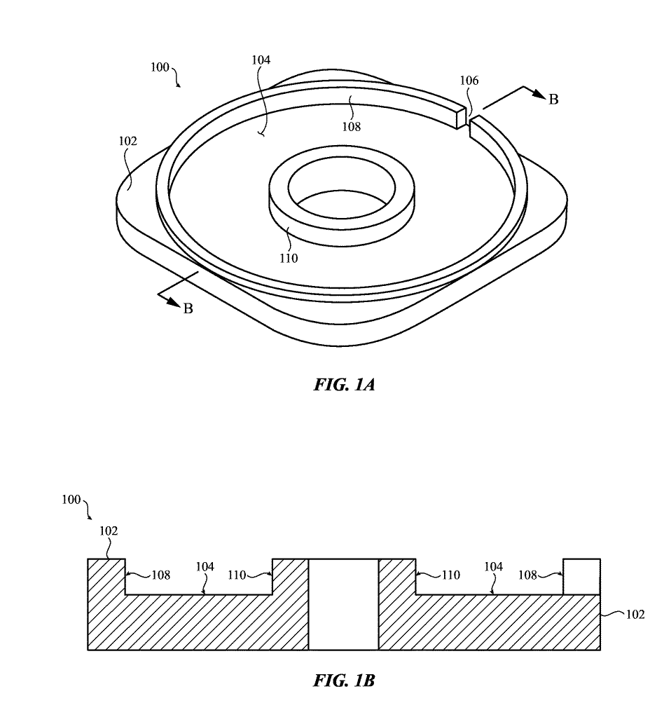

These and other embodiments are discussed below with reference to FIGS. 1-11. However, those skilled in the art will readily appreciate that the detailed description given herein with respect to these figures is for explanatory purposes only and should not be construed as limiting.

FIGS. 1A-1B depict an example coil substrate 100 of an induction coil assembly that may be used to transmit and receive electrical power, data, and other types of electrical signals. In particular, the example coil substrate 100 of FIG. 1A can be used as a base for either a transmitter induction coil or receiver induction coil, discussed below.

In one embodiment, the coil substrate 100 depicted in FIGS. 1A-1B may be formed from ferrite. A ferrite coil substrate may have desirable material properties for use as a coil substrate in an induction coil assembly, including, being a ferromagnetic ceramic and experiencing low losses at high frequencies. In particular, a highly permeable ferromagnetic coil substrate may increase a magnetic field of an inductor and confine it closely to the inductor, thereby increasing the inductance. At high frequencies, ‘soft’ ferrites have a low coercivity, and thus low hysteresis losses.

As shown in FIGS. 1A and 1B, the coil substrate 100 may include a surface 102 that is defined by a coil-receiving region 104 for receiving a conductive winding of an induction coil such as transmitter coil 302 or receiver coil 300, discussed below. The coil-receiving region 104 may be bound or defined by a semicircular outer wall 108. Outer wall 108 may be of sufficient height to contain the coil. For example, it may be taller, shorter, or the same height as the coil. The coil receiving region 104 may also include an inner wall 110 which may help to confine a magnetic field of an induction coil received in the coil-receiving region 104. An aperture 106 defined by opposing ends of outer wall 108 may receive input and output ends of a conductive winding so that they exit at substantially the same location, or substantially the same side of the induction coil received in the coil substrate.

The generally disk-like shape of the coil-receiving region 104 is configured to receive a conductive winding formed from a single wire or similar structure having a cross-layered or multi-layered spiral shape. A spiral-shaped conductive winding (not shown) placed in the disk-shaped coil-receiving region 104 of the substrate 100 may be used to produce an electromagnetic field sufficient to couple to another induction coil, as described herein. In other examples, a conductive winding may be formed from multiple wires and/or formed on multiple surfaces of the coil substrate 100 to further facilitate the production of an electromagnetic field having the desired shape and electrical properties.

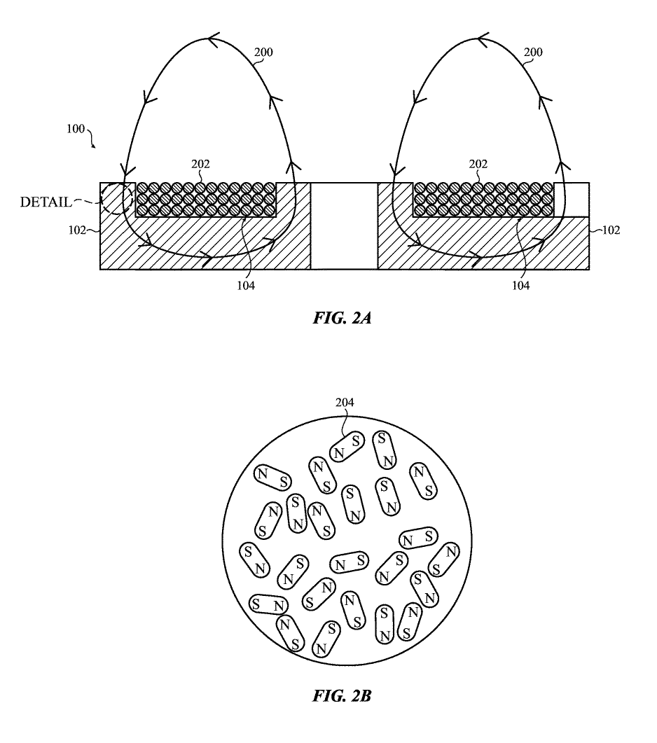

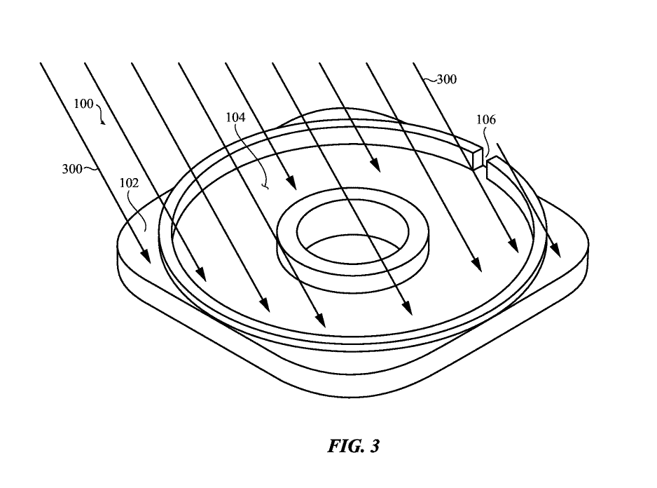

FIG. 2A shows a cross-sectional view of the ferrite coil substrate 100 of FIGS. 1A and 1B, suitable for use in a transmitter device or in a receiver device. As shown in FIG. 2A, an induction coil assembly may be formed from the coil substrate and a conductive winding of an induction coil 202 (cross-sectional portions of a single coil are shown in the figure) contained within the coil-receiving region 104 of the coil substrate 100. As previously discussed, the conductive winding 202 may be formed from a single wire wound into a cross-layered or multi-layered spiral shape, and then placed in the coil-receiving region 104 of the ferrite substrate.

In the embodiment shown in FIG. 2A, induction coil 202 includes three winding layers. As previously noted, induction coil 202 can have a different number of windings arranged in one or more layers in other embodiments. Further, the windings can cross over or between layers. Also, as shown, induction coil 202 is contained within the coil-receiving region 104 of the coil substrate. The walls 108 and 110 of the coil receiving region 104 surround three of the four sides of the induction coil 202. Induction coil 202 can have a shape (or at least one edge of the induction coil can have a shape) that is complementary with the surface region shape. The recess forming the surface region may shape and direct a magnetic field produced by the induction coil 202 towards another induction coil that is proximate to the induction coil 202.

As shown in FIG. 2A, magnetic field 200 may be generated by induction coil 202 during inductive power transmission. In particular, the relationship of the coil substrate 100 and the induction coil 202 may be configured to shape or enhance an electromagnetic field created when an alternating current is passed through the winding. Alternating current conducted through induction coil 202 may create magnetic field 200. This field may couple to a nearby induction coil and the energy of the field may be transformed to a voltage by the nearby coil. The voltage may be used to power an associated electronic device. In an example embodiment, induction coil 202 may be a transmitter coil that is energized by applying a current thereto, which creates a magnetic field 200 that allows a receiver coil to receive voltage when in sufficient proximity to the transmitter coil.

Although FIG. 2A illustrates the magnetic field 200 as circulating in one sample direction, it is understood that this is an example. In other embodiments, the magnetic field 200 may be reversed without departing from the scope of the present disclosure.

Such magnetic field 200 may interact with the ferrite substrate 100. As shown in FIG. 2A, the magnetic field 200 passes through a portion of the substrate 102. Before the magnetic field 200 is generated by an alternating current passing through induction coil, ferrite substrate 100 has magnetic dipoles 204 oriented in random directions, as shown in FIG. 2B, in a detailed view of a portion of the ferrite substrate of FIG. 2A.

When an alternating current passes through induction coil 202 to create magnetic field 200, energy or work is required to align the randomly oriented magnetic dipoles 204 of the ferrite substrate with the magnetic field 200. Therefore, the efficiency and/or effectiveness of power transmission in a power transfer system may be decreased as a result of the randomness of the magnetic dipoles.

To increase and/or improve the efficiency and effectiveness of energy transfer in a power transfer system, the magnetic dipoles of the ferrite substrate may be oriented to be initially aligned with an expected direction of the magnetic field 200 and/or its flux passing through the structure. In this way, energy is not expended during operation (i.e., power transmission) to align the randomly oriented magnetic dipoles. For example, magnetic dipoles of the ferrite substrate may be aligned during processing or manufacture of the ferrite substrate such that they are oriented or aligned with the direction of the magnetic field 200 that is generated by the induction coil 202 during power transmission. As one example, the magnetic dipoles of the ferrite substrate may be aligned during the formation of the ferrite substrate in the sintering process, described herein. A ferrite substrate having magnetic dipoles aligned with a magnetic field may have an increased permeability, and thus may aid in increasing and/or improving the efficiency and/or effectiveness of power transfer in a power transfer system.

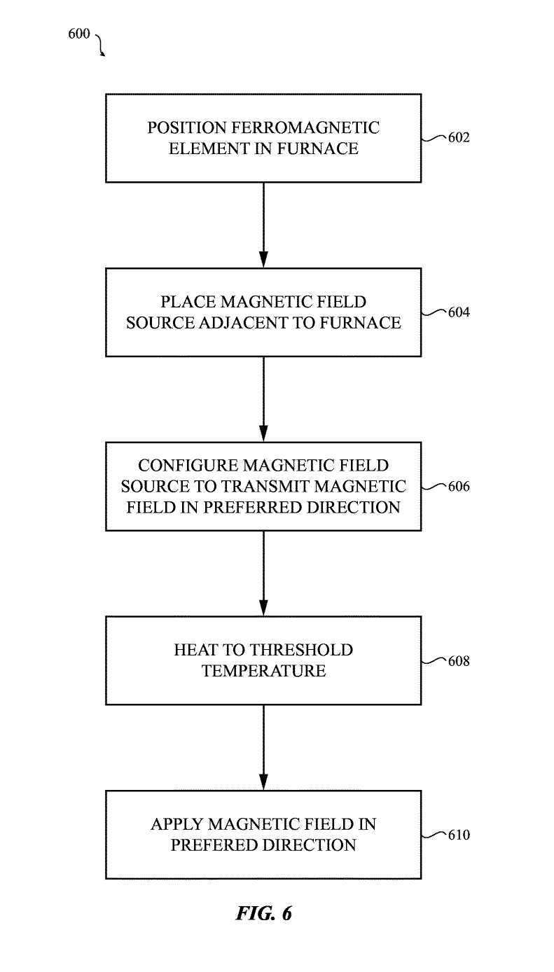

As shown in FIG. 3, the ferrite substrate may be subjected to an external magnetic field. For example, during a sintering process, in order to orient the magnetic dipoles. FIG. 3 depicts one example of an external magnetic field 300 being applied to the ferrite substrate of FIG. 1A. In the example, the magnetic field is applied in a direction that is parallel to outer wall 108 and inner wall 110. As described in more detail below with respect to FIGS. 5 and 6, an external magnetic field 300 is applied during the sintering process used to form the ferrite substrate. That is, the ferrite substrate is subjected to a sintering process and the application of an external magnetic field at the same time in order to lock the magnetic dipoles of the ferrite in a particular orientation.

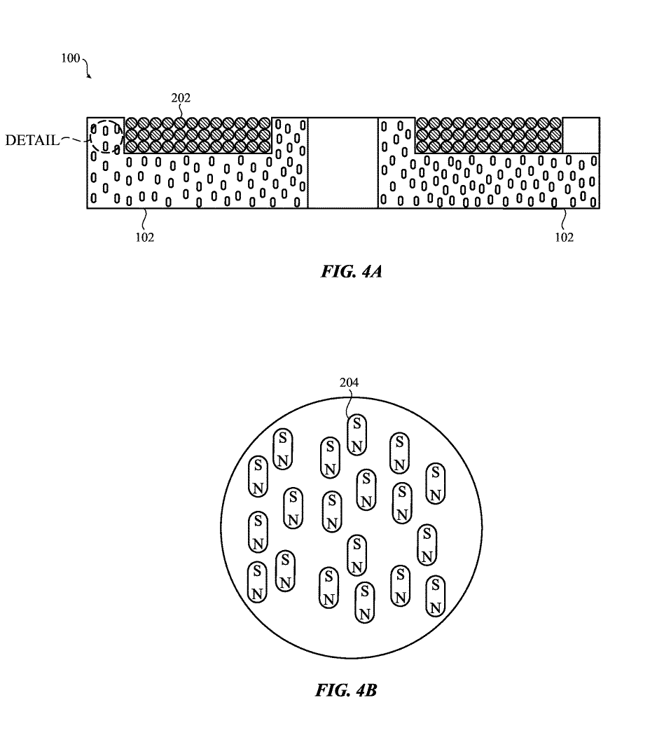

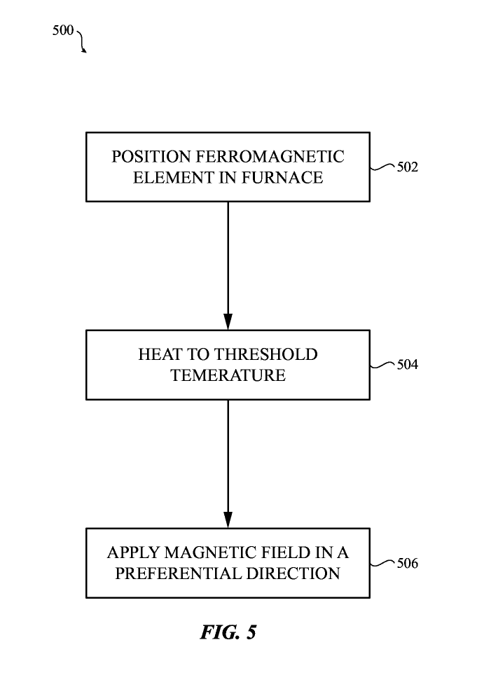

FIG. 4A depicts a cross-sectional view (with cross-hatching removed for ease of viewing) of the ferrite substrate 100 after applying an external magnetic field 300 in accordance with FIG. 3. As shown in the figure, the magnetic dipoles of the ferrite substrate 100 are aligned with the magnetic field 300 applied during the sintering process. This alignment of the magnetic dipoles results in substantially unidirectional dipoles throughout the substrate. This does not necessarily mean that all of the dipoles are parallel to all other dipoles throughout the substrate. Rather, “unidirectionality” as described herein refers to a majority of dipoles in a given volume of the substrate being oriented in substantially the same direction (or nearly the same direction) as one another, even where other dipoles elsewhere in the component are not oriented in the same direction as those in the given volume.

Further, not every dipole in a given area needs to be exactly parallel with other dipoles in that area in order for the dipoles in that area (or the component as a whole) to be considered unidirectional. Rather, the dipoles may be considered unidirectional so long as the dipoles in a given area, in aggregate, trend toward a particular direction. For example, in FIG. 4A, the overall trend of the oriented dipoles is toward a common direction, and thus the dipoles in that area may be considered unidirectional.

FIG. 4B depicts a detailed view of a portion of the ferrite substrate of FIG. 4A. To contrast with FIG. 2B, one or more magnetic dipoles 204 of the ferrite substrate are aligned with the direction of the applied external magnetic field 300, and further aligned with a vertical portion of the generated magnetic field 200 of FIG. 2A. In the example, the portion of the ferrite substrate having aligned magnetic dipoles forms a portion of a side wall of the ferrite substrate of FIG. 2A. In particular, the aligned magnetic dipoles are aligned with the generated magnetic field 200 passing through that side wall portion of FIG. 2A, and stay that way post-application of the field 200.

FIG. 5 depicts an example process 500 for forming a ferrite substrate having oriented magnetic dipoles. FIG. 5 may be used to form, for example, the ferrite substrate described above with respect to FIGS. 1A, 2A, and 3. More generally, the process 500 may be used to form ferrite coil substrates having a variety of shapes and geometries, including, without limitation, spherical, cuboid, cylindrical, conical, or other geometric shape. Further, a coil substrate may also be formed from an irregular shape that conforms to the interior volume of an enclosure or housing or may be formed from a shape that is configured to optimize the creation of an electromagnetic field for electrically coupling to one or more other components.

In operation 502, a ferrite substrate element is positioned in a furnace. The ferrite substrate element being positioned in the furnace may include a ferrite material suspended in a polymer resin and pressed into a desired shape, as discussed above. The ferrite substrate may be inserted in the furnace and placed in a position with respect to an external magnetic field. In particular, the ferrite substrate may be positioned such that an externally applied magnetic field may create a magnetic field in a direction that is aligned with a desired final orientation of magnetic dipoles of the ferrite substrate. The ferrite substrate may be held in place within the furnace with a fixture or other retention mechanism.

In operations 504 and 506, a ferrite substrate having commonly oriented or aligned magnetic dipoles is formed. In accordance with operations 502, discussed above, the ferrite element will have already been positioned in a furnace in a configuration that is aligned with an externally applied magnetic field. The substrate is simultaneously heated in the furnace to a sintering temperature and subjected to an applied external magnetic field in a particular direction.

In accordance with operation 504, the ferrite substrate material may be sintered to form a solid part such as the coil substrate 100. The sintering process may create a solid ferrite substrate having desirable material properties for use as a coil substrate in an induction coil assembly, such as being ferromagnetic, and experiencing low losses at high frequencies.

In particular, the ferrite material is inserted into a polymer resin, pressed into a desired shape, and then sintered in a kiln to form a solid part such as coil substrate 100. In a typical ceramic sintering process, the ferrite part is sintered for around 30 hours in a kiln or furnace at approximately 1325 to 1375 degrees Celsius.

With regard to operation 506, a uniformly distributed magnetic field applied during the sintering process may orient the magnetic dipoles of the ferrite material, and in effect lock the magnetic dipoles in place within the ferrite material of the formed coil substrate. In particular, the external magnetic field may force the magnetic dipoles of the ferrite material into an orientation that facilitates to inductive power transfer. When a coil placed in the coil receiving region is active, the orientation of the magnetic dipoles may be aligned with a magnetic field that is created by the coil during inductive power transmission, and thus the magnetic dipoles will enhance a return path of the field through the substrate during power transfer.

FIG. 6 depicts an example process 600 for applying a magnetic field to a ferrite substrate to orient the magnetic dipoles. In operation 602, a ferrite substrate may be positioned in a furnace used to sinter ferrite material to form a solid ferrite coil substrate. The furnace may be comprised of ceramic components capable of withstanding the high temperatures for sintering ferrite materials.

In accordance with operation 604, a magnetic field source may be placed adjacent to or within the furnace. In one embodiment, a coil capable of creating a desired flux pattern through the ferrite substrate may be placed adjacent to the furnace. In another embodiment, two or more magnets may be placed on opposing sides of the furnace. Since in operation 608, the interior of the furnace will be heated to sintering temperatures (approximately 1325 to 1375 degrees Celsius), a coil capable of creating a magnetic field to be applied to the ferrite substrate within the furnace may be positioned adjacent, surrounding, above, underneath, or in a similar configuration external to the interior of the furnace. In operation 604, a magnetic field source capable of creating a magnetic field in a desired direction is placed adjacent or near to the furnace such that the magnetic field reaches the ferrite substrate in the furnace with enough strength to force the magnetic dipoles of the ferrite substrate into alignment with the magnetic field.

In operation 606, after the magnetic field source is placed adjacent to the furnace containing ferrite substrate, it is configured to transmit a magnetic field in a particular direction through the furnace and/or the substrate part. In particular, the magnetic field source may be configured to apply a magnetic field in a direction that is aligned with a desired final orientation of magnetic dipoles of the ferrite substrate. The desired final orientation of the magnetic dipoles may be aligned with a magnetic field that is created during operation of the coil assembly. Thus the placement of the magnetic field source and configuring the magnetic field to orient the magnetic dipoles may enhance inductive power transfer of any coil or transmission structure employing the sintered part.

As similarly described above in FIG. 5 and operations 504 and 506, in operations 608 and 610, a ferrite substrate having oriented magnetic dipoles is formed. The substrate is simultaneously heated in the furnace to a sintering temperature and subjected to an applied external magnetic field in a particular direction.

In accordance with operation 608, the ferrite substrate material may be sintered to form a solid part such as a coil substrate. The sintering process may create a solid ferrite substrate having desirable material properties for use as a coil substrate in an induction coil assembly, such as being non-conductive, ferromagnetic, and experiencing low losses at high frequencies. Some alternative example materials that can be used to form the coil substrate 100 include, for example, one or more electrically nonconductive materials, soft magnetic material, ferromagnetic material, ceramic materials, crystalline materials, and/or other such materials.

With regard to operation 610, a uniformly distributed magnetic field applied during the sintering process may orient the magnetic dipoles of the ferrite material, and in effect lock the magnetic dipoles in place within the ferrite material of the formed coil substrate. In particular, the external magnetic field may apply a magnetic field that forces the magnetic dipoles of the ferrite material into an orientation that is preferential to inductive power transfer. The preferred orientation of the magnetic dipoles may be aligned with a magnetic field that is created during inductive power transmission, and thus the magnetic dipoles will not need to be re-aligned with this magnetic field during power transfer.

FIG. 6 may be used to form, for example, the ferrite substrate described above with respect to FIGS. 1A, 2A, and 3. More generally, the process 600 may be used to form ferrite coil substrates having a variety of shapes and geometries, discussed above. In some cases, the coil substrate 100 may be formed using a variety of other forming processes, including, for example, injection-molding, open pour casting, vacuum forming, and the like, depending on the material used. The coil substrate 100 may also be formed from chemical reaction between two or more materials that are injected into a mold or cavity also referred to as a reaction-injection molding process.

In some embodiments, forming a ferrite substrate having oriented magnetic dipoles may be accomplished in a series of operations occurring in multiple parts. In particular, the ferrite substrate may be sintered in accordance with the sintering processes described above to a partially-sintered state. The partially-sintered ferrite substrate may then be subjected to a magnetic field in a preferred direction which aligns magnetic dipoles of the ferrite substrate with the preferred direction of the magnetic field. Finally, the partially-sintered ferrite substrate having aligned magnetic dipoles may be further sintered to a fully-sintered state to form a solid ferrite substrate having oriented magnetic dipoles.

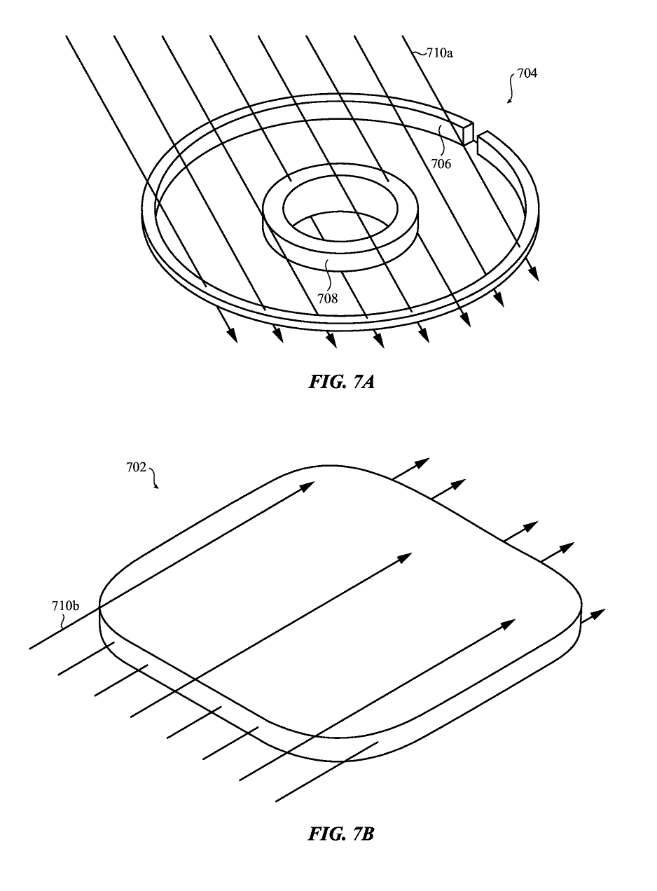

Further, as shown in FIGS. 7A and 7B, the ferrite substrate may be formed from one or more discrete components, the components each undergoing simultaneous sintering and application of a magnetic field to orient the magnetic dipoles of the individual components, and then the components may be connected or otherwise joined to form a coil substrate in accordance with embodiments described herein. It will be appreciated that this permutation of a ferrite substrate formed of components each having magnetic dipoles oriented in a preferred direction, may result in a ferrite substrate having an overall magnetic dipole orientation that more closely aligns with a magnetic field that is generated during inductive power transmission.

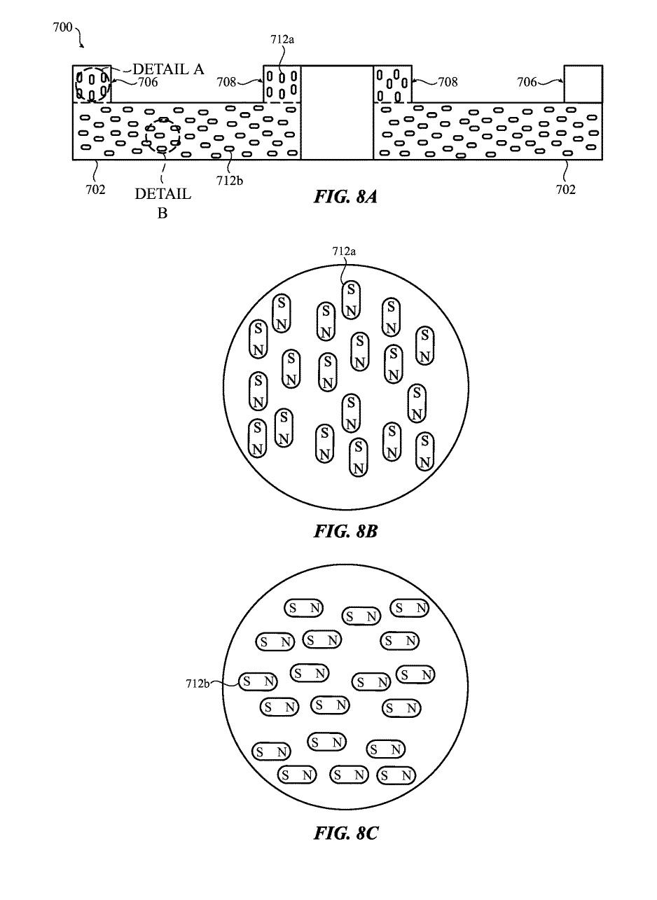

In particular, a ferrite substrate element 700 may be formed from two or more parts. In one example, the ferrite substrate may be formed from two parts: a base portion 702 and a wall portion 704. The part forming the base portion and part forming the wall portion may be separately processed and then the parts may be joined together to form a coil substrate 700, as shown in FIG. 8A. The part forming the wall portion 704 may be sintered and simultaneously subjected to a magnetic field 710a that is parallel to the vertical plane of outer wall 706 and inner wall 708 in order to orient the magnetic dipoles of the part in that direction. Separately, the part forming the base portion 702 may be sintered and simultaneously subjected to an external magnetic field 710b in a direction that is parallel to the horizontal plane of the base 702 in order to orient the magnetic dipoles of the part in that direction. Once the parts have undergone processing and each have oriented magnetic dipoles, the parts may be joined to form a coil substrate 700 similar to the ones shown in the drawings.

As depicted in FIG. 8A, in a cross-sectional view (with cross-hatching removed for ease of viewing) of the coil substrate 700, the magnetic dipoles 712a and 712b are substantially unidirectionally aligned with the magnetic fields 710a and 710b, respectively, which were applied during the sintering process in FIGS. 7A-B. In particular, the dipoles in detail A are all oriented in substantially the same direction as one another, and the dipoles in detail B are all oriented in substantially the same direction as one another, but the dipoles in detail A are perpendicular to the dipoles in detail B.

As further shown in FIGS. 8B and 8C, in detailed views of detail A (FIG. 8B) and detail B (FIG. 8C) of FIG. 8A, the magnetic dipoles 712a and 712 b are substantially unidirectionally aligned with a generated magnetic field that passes through those portions of the coil substrate 700. In this embodiment, a magnetic field generated by an induction coil in a coil receiving region of the composite coil substrate 700 may be aligned with the substantially unidirectional orientation of the magnetic dipoles in the wall portion 704 and the base portion 702.

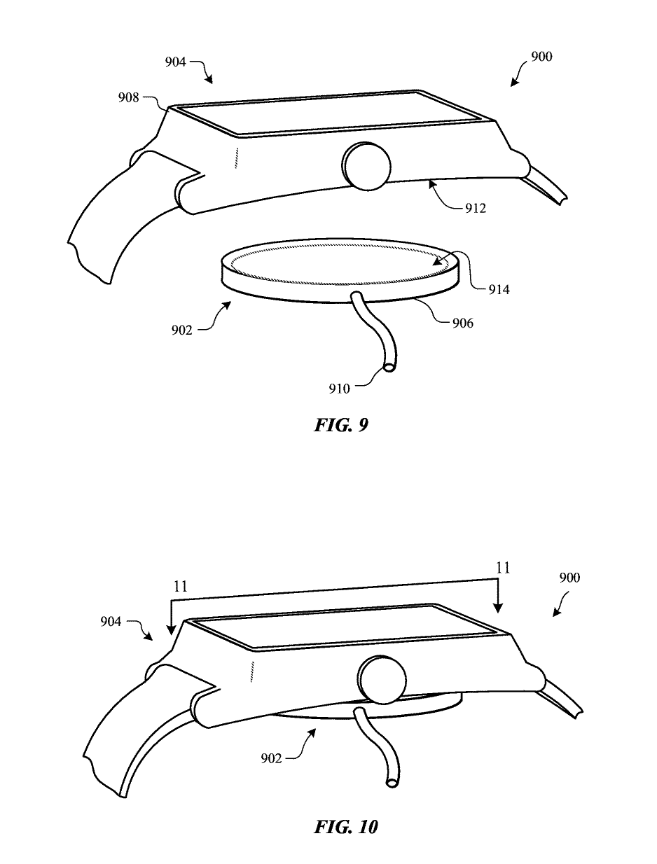

As described herein, the induction coil assembly may form part of an inductive energy transfer system. FIGS. 9 and 10 show one example of an inductive energy transfer system 900 in an unmated configuration. The illustrated embodiment shows a transmitter device 902 that is configured to wirelessly pass energy to a receiver device 904. The receiver device 904 can be any electronic device that includes one or more inductors, such as a portable electronic device or wearable accessory.

The wearable accessory, such as depicted in FIGS. 9 and 10, may be configured to provide, for example, wireless electronic communication from other devices, and/or health-related information or data such as but not limited heart rate data, blood pressure data, temperature data, oxygen level data, diet/nutrition information, medical reminders, health-related tips or information, or other health-related data. The associated monitoring device may be, for example, a tablet computing device, phone, personal digital assistant, computer, and so on.

A wearable accessory may include a coupling mechanism to connect a strap or band useful for securing the wearable accessory to a user. For example, a smart watch may include a band or strap to secure to a user's wrist. In another example, a wearable health assistant may include a strap to connect around a user's chest, or alternately, a wearable health assistant may be adapted for use with a lanyard or necklace. In still further examples, a wearable communication device may secure to or within another part of a user's body. In these and other embodiments, the strap, band, lanyard, or other securing mechanism may include one or more electronic components or sensors in wireless or wired communication with the accessory. For example, the band secured to a smart watch may include one or more sensors, an auxiliary battery, a camera, or any other suitable electronic component.

In many examples, a wearable accessory, such as depicted in FIGS. 9 and 10, may include a processor coupled with or in communication with a memory, one or more communication interfaces, output devices such as displays and speakers, one or more sensors, such as biometric and imaging sensors, and one or more input devices such as buttons, dials, microphones, and/or touch-based interfaces. The communication interface(s) can provide electronic communications between the communications device and any external communication network, device or platform, such as but not limited to wireless interfaces, Bluetooth interfaces, Near Field Communication interfaces, infrared interfaces, USB interfaces, Wi-Fi interfaces, TCP/IP interfaces, network communications interfaces, or any conventional communication interfaces. The wearable device may provide information regarding time, health, statuses or externally connected or communicating devices and/or software executing on such devices, messages, video, operating commands, and so forth (and may receive any of the foregoing from an external device), in addition to communications.

Although the system 900 illustrated in FIGS. 9 and 10 depicts a wristwatch or smart watch, any electronic device may be suitable to receive energy inductively from a transmitter device. For example, a suitable electronic device may be any portable or semi-portable electronic device that may receive energy inductively (“receiver device”), and a suitable dock device may be any portable or semi-portable docking station or charging device that may transmit energy inductively (“transmitter device”).

The transmitter device 902 and the receiver device 904 may each respectively include a housing 906, 908 to enclose electronic, mechanical and structural components therein. In many examples, and as depicted, the receiver device 904 may have a larger lateral cross section than that of the transmitter device 902, although such a configuration is not required. In other examples, the transmitter device 902 may have a larger lateral cross section than that of the receiver device 904. In still further examples, the cross sections may be substantially the same. And in other embodiments, the transmitter device can be adapted to be inserted into a charging port in the receiver device.

In the illustrated embodiment, the transmitter device 902 may be connected to a power source by cord or connector 910. For example, the transmitter device 902 can receive power from a wall outlet, or from another electronic device through a connector, such as a USB connector. Additionally or alternatively, the transmitter device 902 may be battery operated. Similarly, although the illustrated embodiment is shown with the connector 910 coupled to the housing of the transmitter device 902, the connector 910 may be connected by any suitable means. For example, the connector 910 may be removable and may include a connector that is sized to fit within an aperture or receptacle opened within the housing 906 of the transmitter device 902.

The receiver device 904 may include a first interface surface 912 that may interface with, align or otherwise contact a second interface surface 914 of the transmitter device 902. In this manner, the receiver device 904 and the transmitter device 902 may be positionable with respect to each other. In certain embodiments, the second interface surface 914 of the transmitter device 902 may be configured in a particular shape that mates with a complementary shape of the receiver device 904 (see FIG. 10). The illustrative second interface surface 914 may include a concave shape that follows a selected curve. The first interface surface 912 of the receiver device 904 may include a convex shape following the same or substantially similar curve as the second interface surface 914.

In other embodiments, the first and second interface surfaces 912, 914 can have any given shape and dimension. For example, the first and second interface surfaces 912, 914 may be substantially flat. Additionally or alternatively, the transmitter and receiver devices 902, 904 can be positioned with respect to each other using one or more alignment mechanisms. As one example, one or more magnetic devices may be included in the transmitter and/or receiver devices 902 and used to align the transmitter and receiver devices. In another example, one or more actuators in the transmitter and/or receiver devices 902 can be used to align the transmitter and receiver devices. In yet another example, alignment features, such as protrusions and corresponding indentations in the housings of the transmitter and receiver devices, may be used to align the transmitter and receiver devices. The design or configuration of the interface surfaces, one or more alignment mechanisms, and one or more alignment features can be used individually or in various combinations thereof.

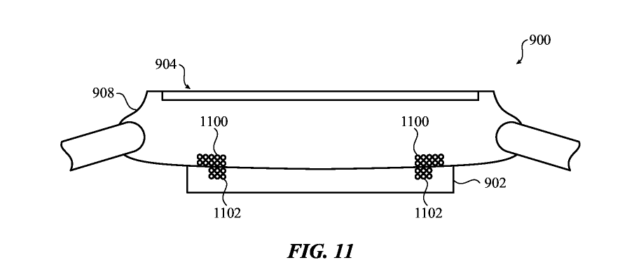

FIG. 11 depicts a side cross-sectional view of the inductive energy transfer system taken along line 11-11 in FIG. 10. As discussed earlier, both the transmitter device 902 and the receiver device 904 can include electronic, mechanical, and/or structural components. For example, the receiver device 904 can include one or more processing devices, memory, a display, one or more input/output devices such as buttons, microphone, and/or speaker(s), a communication interface for wired and/or wireless communication, and a touch input device (which may or may not be incorporated into the display). The illustrated embodiment of FIG. 11 omits certain electronic, mechanical, and/or structural components for simplicity and clarity.

FIG. 11 shows the example inductive energy transfer system in a mated and aligned configuration. The transmitter device 902 transfers energy to the receiver device 904 through inductively coupling between their respective induction coils: a transmitter coil 1102 in the transmitter device 902 and a receiver coil 1100 in the receiver device 904. The receiver device 904 includes one or more receiver coils having one or more windings. The receiver coil 1100 may receive energy from the transmitter device 902 and may use the received energy to perform or coordinate one or more functions of the receiver device 904, and/or to replenish the charge of a battery (not shown) within the receiver device 904. In the illustrated embodiment, the receiver coil 1100 includes ten windings arranged in two layers or rows. The receiver coil 1100 can have a different number of windings arranged in one or more layers in other embodiments.

Similarly, the transmitter device 902 includes one or more transmitter coils having one or more windings. The transmitter coil 1102 may transmit energy to the receiver device 904. In the illustrated embodiment, the transmitter coil 1102 includes six windings arranged in two layers. In other embodiments, the transmitter coil 1102 can have a different number of windings arranged in one or more layers.

The transmitter and receiver coils can be implemented with any suitable type of inductor. Each coil can have any desired shape and dimensions. The transmitter and receiver coils can have the same number of windings or a different number of windings. Typically, the transmitter and receiver coils are surrounded by an enclosure to direct the magnetic field in a desired direction (e.g., toward the other coil). The enclosures are omitted in FIG. 11 for simplicity.

The transmitter coil 1102 and the receiver coil 1100 together form a transformer. The transformer transfers power or energy through inductive coupling between the transmitter coil 1102 and the receiver coil 1100. Essentially, energy is transferred from the transmitter coil 1102 to the receiver coil 1100 through the creation of a varying magnetic field by an AC signal in the transmitter coil 1102 that induces a current in the receiver coil 1100. The AC signal induced in the receiver coil 1100 is received by an AC-to-DC converter (not shown) that converts the AC signal into a DC signal. In embodiments where the load is a rechargeable battery, the DC signal is used to charge the battery. Additionally or alternatively, the transferred energy can be used to transmit communication signals to or from the receiver device.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method for forming a ferrite element having oriented magnetic dipoles, comprising:
heating the ferrite element to a first temperature, the ferrite element comprising a non-magnetic matrix having magnetic particulates suspended therein; and
while heating, applying an external magnetic field to the ferrite element, thereby aligning the magnetic dipoles of the particulates with the magnetic field.

2. The method of claim 1, wherein:
heating the ferrite element to the first temperature partially sinters the ferrite element; and
further comprising heating the partially-sintered ferrite element to a second temperature to fully sinter the ferrite element; and
applying the external magnetic field to the ferrite element occurs between heating the ferrite element to the first temperature and heating the partially-sintered ferrite element to the second temperature.

3. The method of claim 1, wherein the ferrite element is configured to hold an induction coil.

4. The method of claim 3, wherein the aligned magnetic dipoles of the particulates are aligned with a magnetic field of the induction coil during operation of the induction coil.

5. The method of claim 4, wherein the aligned magnetic dipoles increase the permeability of the ferrite element.

6. The method of claim 5, wherein the increased permeability of the ferrite element improves power transmission efficiency of the induction coil.

7. A method for improving power transmission in an inductive power transfer system, comprising:
forming a coil substrate from a ferrite material having substantially unidirectionally oriented magnetic dipoles;
disposing an induction coil on a surface of the coil substrate.

8. The method of claim 7, wherein forming the coil substrate comprises:
heating the ferrite material to a threshold temperature; and
applying a magnetic field to the ferrite material during heating to align magnetic dipoles of the ferrite material with the magnetic field.

9. The method of claim 7, wherein the magnetic dipoles of the ferrite material are oriented in a direction corresponding to a direction of an intersecting magnetic field of the induction coil.

10. The method of claim 7, further comprising:
forming two or more substrate components from a ferrite material, the two or more substrate components each comprised of oriented magnetic dipoles; and
joining the two or more substrate components to form the coil substrate.

11. The method of claim 10, wherein forming two or more substrate components comprises:
forming two or more substrate parts each forming a distinct portion of a coil substrate having a combined shape capable of receiving the induction coil;
heating each of the two or more substrate parts to a threshold temperature; and
during heating of each of the two or more substrate parts, applying a magnetic field to each of the two or more substrate parts to generally align magnetic dipoles of the ferrite material with the magnetic field being applied.

12. The method of claim 10, wherein joining the two or more substrate components results in a coil substrate having an aggregate magnetic dipole orientation that substantially aligns with a magnetic field of the induction coil in an inductive power transfer system.

13. An induction coil substrate, comprising:
a ferrite material having substantially unidirectionally oriented magnetic dipoles; and
a coil-receiving region on a surface of the substrate.

14. The induction coil substrate of claim 13, further comprising an induction coil in the coil-receiving region.

15. The induction coil substrate of claim 14, wherein the magnetic dipoles of the ferrite material are substantially parallel to a magnetic field of the induction coil.

16. The induction coil substrate of claim 15, wherein the alignment of the magnetic dipoles improves power transmission efficiency of the induction coil.

17. The induction coil substrate of claim 13, wherein the substrate is formed of two or more parts, each comprised of a ferrite material having substantially unidirectionally oriented magnetic dipoles.

18. The induction coil substrate of claim 17, wherein the magnetic dipoles of each part respectively substantially align with an intersecting magnetic field of an induction coil in the coil-receiving region.

19. The induction coil substrate of claim 13, wherein the ferrite material having substantially unidirectionally oriented magnetic dipoles is formed in a process that simultaneously sinters and applies an external magnetic field to the substrate.

20. The induction coil substrate of claim 19, wherein applying an external magnetic field substantially aligns the magnetic dipoles of the ferrite material with the magnetic field.
